(19) United States
(12) Patent Application Publication
(10) Pub. No.: US 2024/0359865 A1
(43) Pub. Date: Oct. 31, 2024

(54) MODULAR ENERGY PALLET

(71) Applicant: Universal City Studios LLC, Universal City, CA (US)

(72) Inventors: Joseph Daniel Madden, Orlando, FL (US); Morris Andre VanKerschaever, Apopka, FL (US)

(21) Appl. No.: 18/307,966

(22) Filed: Apr. 27, 2023

(51) Int. Cl. B65D 19/38; A63J 5/02; H02J 7/00; H02J 7/34

(52) U.S. Cl. CPC B65D 19/38; H02J 7/0047; H02J 7/0063; H02J 7/342; A63J 5/02; B65D 2519/00323; B65D 2519/00965; H02J 2207/20; H02J 2310/40

(57) ABSTRACT

A flexible use modular energy pallet is provided herein. The modular energy pallet includes AC and DC outlets which may be dynamically enabled for use in a variety of applications. The modular energy pallet may be used in conjunction with other modular energy pallets to provide variable power output for different applications.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Amusement parts and other entertainment venues oftentimes utilize attraction components, such as vehicles, floats, lighting displays, etc. that require energy to provide a desirable user experience. These attraction components may vary in power consumption greatly, resulting in custom built power solutions for each implementation. In some cases, when substantial power is needed, large internal combustion generators may be used, which are large, loud, and difficult to maintain. Further, many attraction components are seasonal, resulting in the custom-built power sources only being used during seasonal periods when the attraction components are active. Accordingly, to increase efficiency and decrease costs, described herein are modular energy pallets with multiple outputs, both in power connection type and power output, enabling re-use amongst a variety of applications. Further, additional features, such as wireless access points, work lights, etc. which may be used across attraction components may also be integrated into the module energy pallets, creating new efficiencies in attraction component administration.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

The current disclosure relates generally to energy supply. Specifically, the current disclosure relates to modular energy pallets useful for supplying energy to and controlling entertainment attractions. Specifically, embodiments described herein provide flexible power output, by enabling linear in-series connection of connectable modular energy pallets to suit a variety of implementations. Further, these modular energy pallets may include additional features that aid in administration of entertainment features, such as a wireless access point for entertainment attraction control, one or more work lights, and multiple switchable outlets, some of varied connector types. In this manner, the modular energy pallets provide significant flexibility in one or more self-sustaining units.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an illustration of a system that utilizes one or more modular energy pallets for a variety of applications, in accordance with one or more embodiments of the current disclosure;

FIG. 2 is an isometric front view of a modular energy pallet with a top cover removed, illustrating various features of the module energy pallet, in accordance with one or more embodiments of the current disclosure;

FIG. 3A is an isometric back view of a modular energy pallet with the cover attached, illustrating features of the modular energy pallet, in accordance with one or more embodiments of the current disclosure;

FIG. 3B is a front view of two modular energy pallets stacked for increased energy provision, in accordance with one or more embodiments of the current disclosure;

FIG. 4 is a schematic diagram of a modular energy pallet control and patch panel, illustrating inputs and outputs of modular energy pallet, in accordance with one or more embodiments of the current disclosure;

FIGS. 5A and 5B (collectively referred to as “FIG. 5” herein) illustrate a wiring diagram, illustrating connections of a 19-pin output version of a modular energy pallet, in accordance with one or more embodiments of the current disclosure; and

FIGS. 6A and 6B (collectively referred to as “FIG. 6” herein) illustrate a wiring diagram, illustrating connections of a weatherproof locking output version of a modular energy pallet, in accordance with one or more embodiments of the current disclosure.

### DETAILED DESCRIPTION

The present disclosure relates generally to modular energy pallets that may be used in the administration of attraction components, such as vehicles, floats, lighting displays, etc.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Further, as may be appreciated, when data and/or power delivery/communications are disclosed herein, it should be understood that data communications may include communications via wired and/or wireless communications (e.g., via Wi-Fi, Bluetooth, Radio Frequency (RF), etc.). Further, power delivery may be wired (e.g., through a physical connector and/or wireless (e.g., electromagnetic power transfer). Though specific examples of data communications and power delivery are described herein, the current discussion is intended to provide examples of the systems and techniques described herein and is not intended to limit embodiments to such examples.

Present embodiments of the disclosure are directed to systems and methods for flexible power solutions for attraction components. More specifically, modular energy pallets may be used individually or in combination with one another to provide a variety of power output levels and/or power output connection types. Further, additional features, such as work lighting, wireless access points, and the like that may help foster attraction component administration may also be included in the modular energy pallets, resulting in increased usability in the field.

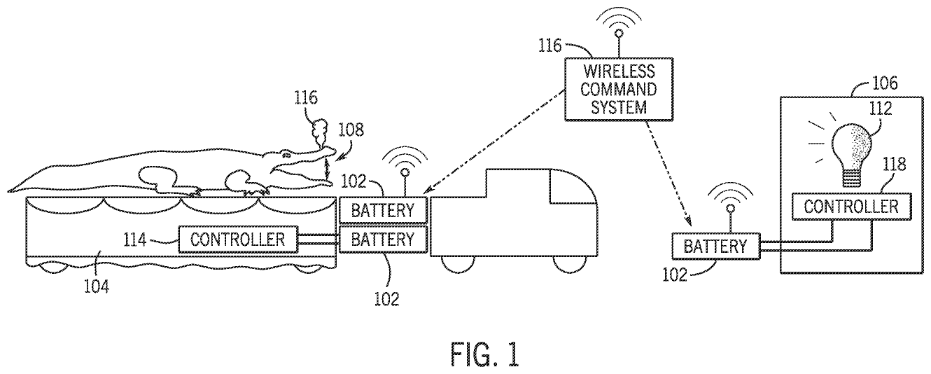

FIG. 1 is an illustration of a system 100 that utilizes one or more modular energy pallets 102 for a variety of applications, in accordance with one or more embodiments of the current disclosure. Specifically, the system 100 includes a entertainment vehicle 104 and a mobile lighting display 106 that make use of the modular energy pallets 102 to power respective features. For example, the entertainment vehicle 104 may use the modular energy pallets 102 to provide power to actuate features such as a moving mouth 108 and/or a smoke generating feature 110. Further, mobile lighting display 106, may use a modular energy pallet 102 to power light 112.

The modular nature of the modular energy pallets 102 enable a multitude of power output levels to be provided by the modular energy pallets 102. For example, the entertainment vehicle 104, with its relatively grander features may require more power than the mobile lighting display 106. Rather than creating energy pallets with varied amount of power output for these different applications, the modular energy pallets 102 may each provide a consistent power output, while being enabled to connect, in a linear in-series fashion with other modular energy pallets 102, resulting in additive power output. In this manner, a customized amount of power output may be provided by connecting, in a linear in-series fashion additional modular energy pallets 102 to one another. As illustrated, the entertainment vehicle 104 makes use of two modular energy pallets 102 connected, in a linear in-series fashion, while the mobile lighting display uses one modular energy pallet 102.

The modular energy pallets 102 may provide power via a number of different power connection types. Each connector may be weatherproof, enabling operation in various climate conditions, such as rain, snow, etc. In some embodiments, for example, the modular energy pallet 102 may be equipped with a 120 volts alternating current (VAC) output from onboard inverters that pass through Ground Fault Circuit Interrupters.

In some embodiments, a bulkhead direct current (DC) (e.g., 51VDC 51A) output that pulls power directly from an onboard battery of the modular energy pallet 102 may be provided. This connection type may provide a significant amount of DC power to attraction components requiring such supply.

Further, in some embodiments, other connectors, such as a weatherproof locking bulkhead output may be provided via the modular energy pallet 102, which provides alternating current (AC) power. In such embodiments, AC power may be supplied to the modular energy pallet 102 via a weatherproof locking bulkhead connector. When more current is required than the onboard inverters of one modular energy pallet 102 can provide, another modular energy pallet 102 may be coupled to the first modular energy pallet 102, with individual AC power cables being connected to both modular energy pallets 102.

In some embodiments, wireless and/or wired pin outputs for data and/or power may be provided. For example, in one embodiment, a 19-Pin output (e.g., a Socapex or Soco output) is provided. In such embodiments, the main output of the unit may be run through a subset of pins via a connector. For example, in a 19-pin output, the main output of the unit may be run through a 10-pin (6 channel) connector. A subset of the channels are dedicated to the onboard inverters, while other channels are left open and make be used to patch in power from the outputs of additional modular energy pallets 102.

As mentioned above, additional features that help facilitate administration of attraction components may also be provided by the modular energy pallets 102. For example, the modular energy pallets 102 may include a wireless access point onboard, enabling wireless communication with the attraction components. For example, the wireless access point may include a waterproof bulkhead ethernet port that may be couple with communication systems of the attraction component. The wireless access point may be selectively enabled and may be powered, when enabled, by the onboard battery of the modular energy pallet 102.

In the system 100 of FIG. 1, an onboard vehicle controller 114 may communicatively couple to a selectively enabled access point of one of the modular energy pallets 102. In this manner, a physical ethernet connection to the access point may be provided to the onboard vehicle controller 114, enabling control of the entertainment vehicle 104 by a wireless command system 116, which may send wireless commands to the enabled access point. Similarly, a controller 118 of the mobile lighting display 106 may be connected to a selectively enabled access point of a coupled modular energy pallet, enabling a wireless command system 116 to provide wireless commands to the controller 118 to affect change in the mobile lighting display.

Further, the modular energy pallets 102 may include work lighting. The work lighting may be selectively enabled by an operator and may provide operator convenience and safety when operating the attraction components and/or modular energy pallet. When enabled, the work lighting may be powered by the onboard battery of the modular energy pallet 102.

While the system 100 illustrates two different types of attraction components, a entertainment vehicle 104 and a mobile lighting display 106, this is not intended to limit their use to these specific types of attraction components. Indeed, many other attraction components may make use of the modular energy pallets, resulting in cost-effective and highly useful power source solutions.

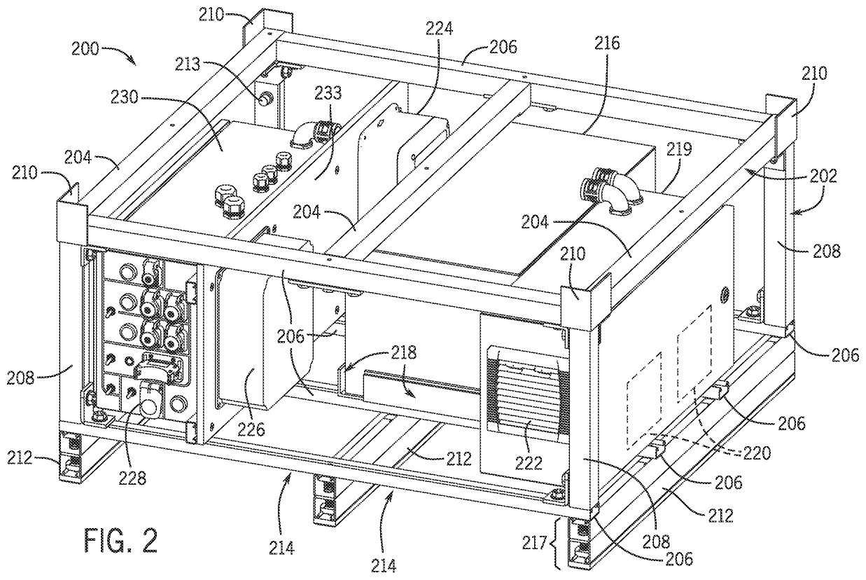

Turning now to a more detailed view of the modular energy pallets 102, FIG. 2 is an isometric front view of a modular energy pallet 200 with a top cover removed, illustrating various features of the module energy pallet, in accordance with one or more embodiments of the current disclosure. As illustrated, the modular energy pallet 200 includes structural framing 202 that surrounds the onboard components of the modular energy pallet 200. The framing includes vertical framing members 204 and horizontal framing members 206 attached by corner members 208. The structural framing 202 includes stacking cups 210 and skid rails 212 that enable stacking of additional modular energy pallets 200. Specifically, the skid rails 212 are sized such that they fit within stacking cups 210 of another modular energy pallet 200. When stacked, the skid rails 212 of one modular energy pallet 200 may rest on top of the vertical framing members 204, optionally with a top cover installed between the top of the vertical framing members 204 and the skid rails 212. One or more chassis ground points 213 may be disposed on the structural framing 202 (e.g., on a corner member 204). The chassis ground points 213 may be used to bond stacked modular energy pallets together and/or to attach a grounding strip, which may be beneficial, for example, to dissipate static electricity.

The skid rails 212 are situated such that one or more fork pockets 214 are formed. A fork pocket 214 is a void where a prong of a forklift may be inserted to enable the forklift to move the modular energy pallet 200. The skid rails may include a height 217 that is tall enough to allow for clearance of a forklift prong after a modular energy pallet 200 is stacked on another modular energy pallet 200. In other words, the height 217 may be greater than a typical thickness of a forklift prong (e.g., 1.5 inches), enabling a forklift prong to be removed after the modular energy pallet 200 is stacked.

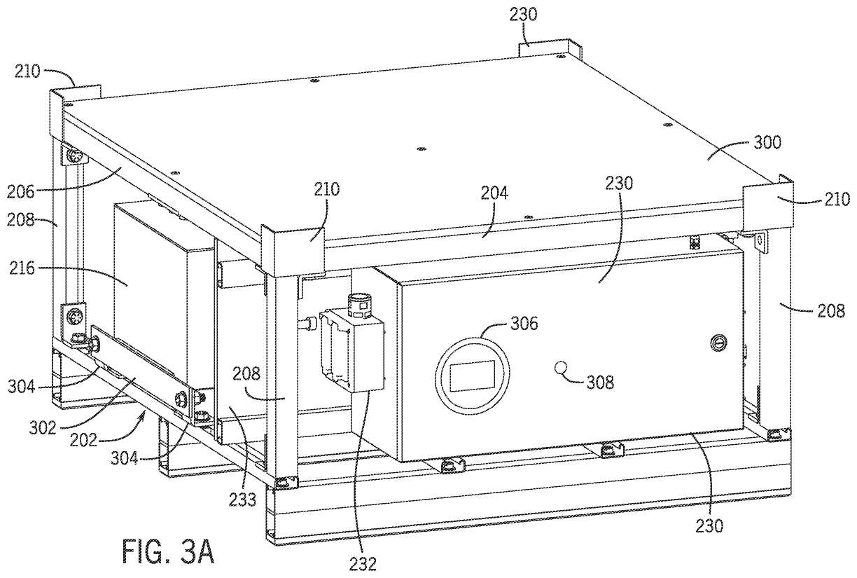

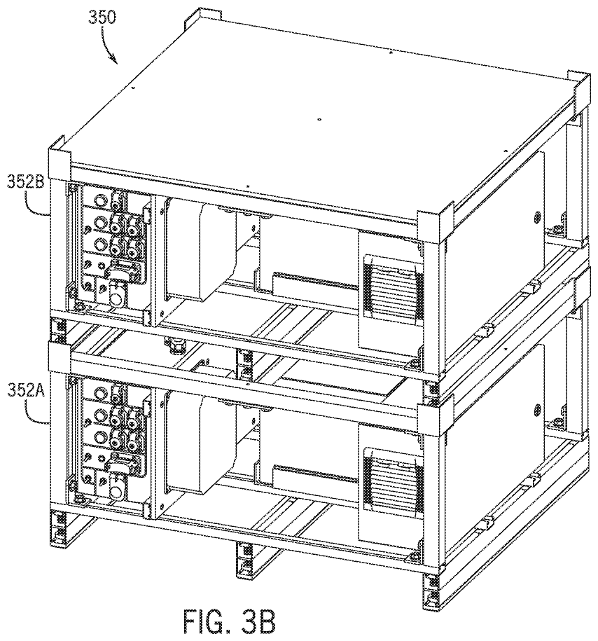

Turning now to the internal components, the modular energy pallet 200 includes a power source, here a battery 216, that will provide power to the attraction components. In some embodiments, the battery 216 may be a 51V 150 Ah battery, which may be suitable for powering and/or partially powering many different attraction components. The modular energy pallet 200 may include an internal void where the battery 216 may be disposed and/or dropped in. In the example provided in FIG. 2, the battery 216 is held in place by battery restraints 218, affixed to the structural framing 202 (e.g., at horizontal framing members 206). The battery restraints 218 may be angled aluminum, shaped to the contours of the battery 216, such that the battery 216 is restrained from lateral movement when installed. As will be discussed in more detail with respect to FIG. 3, the battery restraints 218 may include a securing system that causes the battery 216 to be secured within the modular energy pallet 200. While in some embodiments the battery 216 may not be removable, in some embodiments, the securing system may include a mechanical locking system (e.g., mechanism) that, when engaged, restrains the battery 216 and when disengaged, allows for at least partial removal of the battery 216, such as by allowing lateral movement in a single direction for easy removal of the battery 216. In this manner, the battery 216 may be easily removed for repair and/or replacement when necessary.

The modular energy pallet 200 also includes an inverter cabinet 219, which may house one or more inverters. In the depicted embodiment, two inverters 220 are housed in the inverter cabinet 219. The inverters 220 may convert DC power to AC power, enabling AC power applications of the modular energy pallet 200. Vents (e.g., slotted vents, louvered vents, etc.) 222 may be included allow for forced air cooling of the inverters 220.

The modular energy pallet 200 may also include a battery management system (BMS) 224. The BMS 224 provides real-time control of the battery 216 to operate within rated specifications. The BMS 224 may provide operations such as battery cell monitoring, over-charge (e.g., high-voltage cutoff) protection, over-discharge (e.g., low-voltage cutoff) protection, general battery 216 health monitoring, and other battery management functions. In some embodiments, the BMS 224 may also include a communicative coupling (e.g., wired and/or wireless, such as via Wi-Fi, Bluetooth, and/or Near Field Communications) that enables battery 216 statistics to be communicated/presented to operators of the modular energy pallet 200.

The BMS 224 may identify when charging of the battery 216 should occur and provide instructions to facilitate charging via the charger 226. The charger 226 may receive external power (e.g., VAC power) and charge the battery 216, in accordance with instructions from the BMS 224 charging control. The charger 226, in a current embodiment may be a 51V 16 Cell (16S) charger.

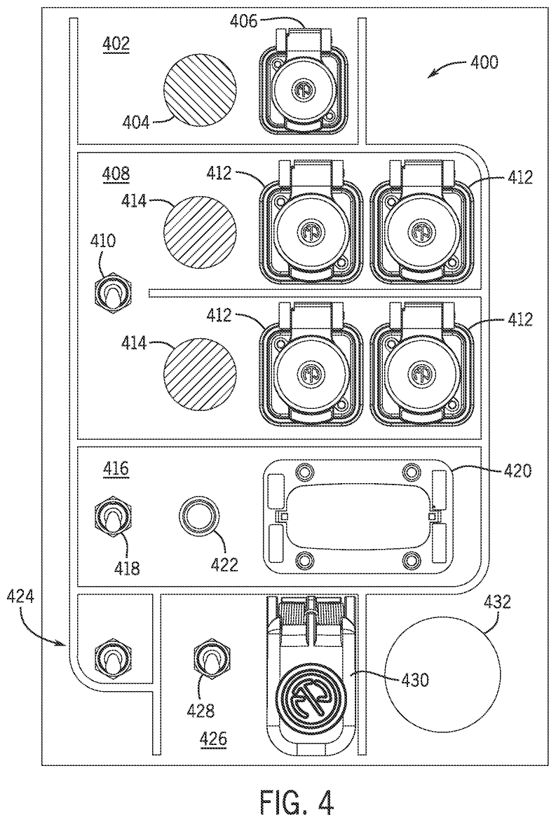

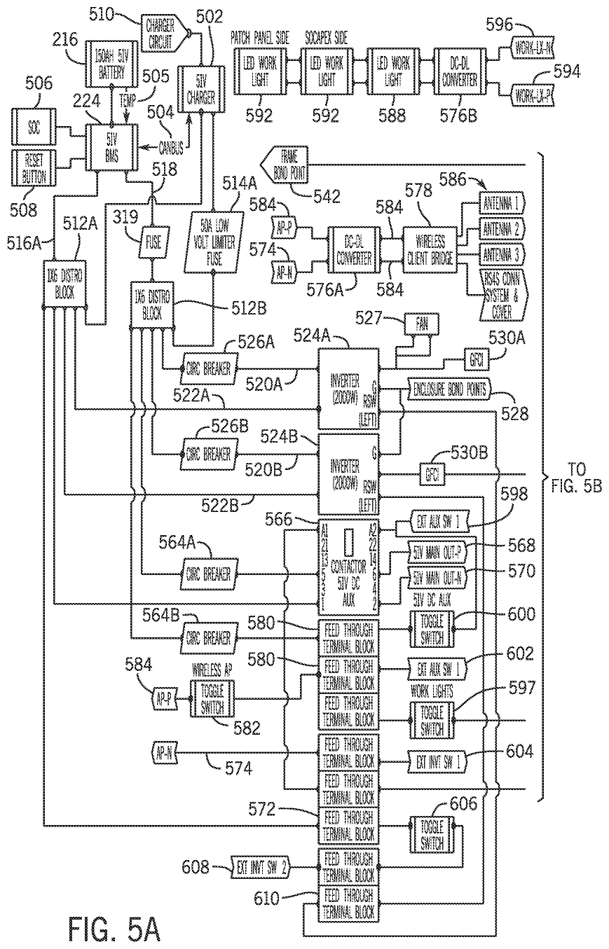

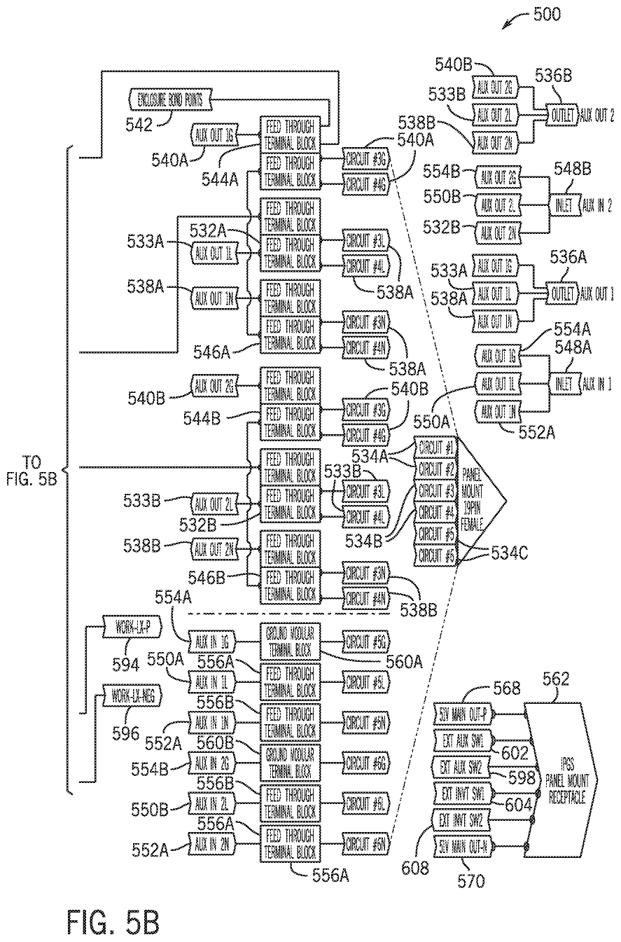

The modular energy pallet 200 includes a control and patch panel 228 that provides inputs and output connections of the modular energy pallet 200. The connection details will be described in more detail with regards to FIGS. 4 and 5. The control and patch panel 228 organizes the input and output cables between the input and output connectors and the charger 226, and BMS 224. The control and patch panel 228 may, in some embodiments, be disposed on or make up an externally facing wall of the control cabinet 230. The control cabinet 230, charger 226, and BMS 224 may each couple to a stabilizer plate 233, which is affixed to the horizontal framing members 206. This results in stabilization of each of these components within the modular energy pallet 200.

Turning now to an alternative view of the modular energy pallet 200, FIG. 3 is an isometric back view of the modular energy pallet 200 of FIG. 2, this time with the cover 300 attached, illustrating features of the modular energy pallet, in accordance with one or more embodiments of the current disclosure.

For example, the current view illustrates the previously mentioned battery securing system 302. The securing system 302 may secure the battery 216 using a variety of different techniques and/or mechanisms. For example, in some embodiments, physical securing mechanisms, such as straps, brackets, fasteners, a battery port, etc. may be used. In the example depicted in FIG. 3, the securing system 302, is in the form of a removable bar. When engaged (e.g., when bolted to the bracket(s) 304 affixed to the structural framing 202), the securing system 302 restrains the battery 216. When disengaged (e.g., when unbolted from the bracket(s) 304) the securing system 302 allows for lateral movement in a single direction for easy removal of the battery 216. In this manner, the battery 216 may be easily removed for repair and/or replacement when necessary. In some embodiments, alternative mechanisms, such as a magnetic securing mechanism, a pressure mechanism, etc. may be used. In some embodiments, the securing system 302 may include a locking system that mitigates against unauthorized removal of the battery 216. For example, the locking system may utilize a key-based lock, magnetic lock, etc. to thwart unauthorized removal of the battery 216 via the battery 216 securing system 302. In some embodiments, the locking system may lock removal of the cover 300, which may result in thwarting battery 216 removal from securing systems 302 that use the cover to secure the battery 216.

Further, as illustrated, the control cabinet 230 may include one or more ground fault circuit interrupters (GFCIs) 232. The GFCIs 232 may provide circuit interruption protection when ground faults occur. The GFCIs 232 may be accessible without opening a primary enclosure of the modular energy pallet 200. This may enable the GFCIs 232 to be quickly accessed for resets, etc. Additionally, in an embodiment, the control cabinet 230 may include a battery status gauge 306, which may interface with the BMS 224 in order to provide/display battery information. For example, the battery status gauge 306 may provide voltage, temperature, and/or current draw measurements of the battery 216, and these measurements may be displayed by the BMS 224. In an embodiment, the control cabinet 230 may also include a reset button 308. The reset button 308 is communicatively coupled to the BMS 224 (e.g., in a wired or wireless fashion) and, when actuated, may reset battery statistics maintained by the BMS 224 and/the battery itself (e.g., in the event of a fault). In some embodiments, the reset of the battery may isolate the battery 216 (e.g., for a temporary time) from a load and/or the charger 226, causing the battery 216 to refrain from providing power to the load and/or charging. To do this, the reset button 308 enables operators, via actuation, to open and close a main contactor of the BMS 224, causing the load and/or charging circuits to break. In some embodiments, the reset button 308, when actuated, may also trigger reset of one or more of the battery 216 statistics maintained by the BMS 224.

FIG. 3B illustrates a front view of a stacked energy pallet system 350. The stacked energy pallet system 350 illustrates two independent modular energy pallets 352A and 352B that are placed in a stacked formation, enabling convenient storage and movement. Further, as discussed herein the independent modular energy pallets 352A and 352B may be configured (e.g., via wiring) to provide a combined energy output for higher energy demand applications While only two modular energy pallets are illustrated in the stacked energy pallet system 350, additional modular energy pallets may be stacked and used for additional energy in the stacked energy pallet system 350.

Turning now to a more-detailed discussion of the inputs and outputs of the modular energy pallet 200, FIG. 4 is a schematic diagram of a modular energy pallet control and patch panel 400 illustrating inputs and outputs of modular energy pallet in accordance with one or more embodiments of the current disclosure.

As illustrated, the control and patch panel 400 includes a charging section 402, which may include a charging indicator 404 and a charging port 406. When connected to an external power source, the charging port 406 may supply power to the battery 216, enabling charging of the battery in accordance with the battery management system 224. In some embodiments, the charging port 406 may include an AC power input receptacle, for example in the form of a weatherproof locking bulkhead connector. As power is supplied from an external source for charging, the charging indicator 404 may light or otherwise provide an indication of the charging of the battery 216. The charging indicator 404 may de-activate when external power is not supplied and/or when the Battery Management System 224 pauses charging.

As mentioned herein, each modular energy pallet 200 may be equipped with inverters that provide AC power output. Accordingly, the control and patch panel 400 may include an inverter output section 408 that facilitates AC power output. The inverter output section 408 may include a switch 410 that, when actuated, causes power to from the battery 216, through the inverters, to the inverter outlets 412. When not actuated, the switch 410 disables power flow from the inverters to the inverter outlets 412. In some embodiments, the inverters may each be capable of supplying 120VAC/16A power, while in other embodiments, other inverter capabilities may be present, depending on desired outputs. For example, in some embodiments, the inverters may supply approximately 220VAC. For operator indication of active inverter outlets, the inverter outlet indicators 414 may activate when power is being supplied to outlets 412 via the inverters. In some embodiments, different sets of inverter outlets 412 and inverter outlet indicators 414 may be provided to correspond to the number of inverters within the modular energy pallet 200. For example, in the embodiment of FIG. 4, two sets of inverter outlets 412 and inverter outlet indicators 414 are provided, as there are two onboard inverters.

In some embodiments, the power outlets may be weatherproof locking connections, In such embodiments of the modular energy pallet 200, all AC power out may be supplied by weatherproof locking bulkhead connecters, which may be weatherproof both when in use and when not in use. In such embodiments, when additional current is needed by the applications pulling power from the modular energy pallet 200 than is supplied by the onboard inverters, another modular energy pallet 200 may be stacked, resulting in additional inverter outlets 412 that AC cables can connect to, to supply additional AC current. Additional modular energy pallets 200 may continue to be stacked until a desired amount of AC current is supplied.

In some embodiments, the power outlets may be 19-pin output connections, In such 19-pin output connection embodiments of the modular energy pallet 200, the main power output may be run through a 19-pin (6 channel) connector (e.g., a Socapex or Soco connector), which may be weatherproof when connected and protected by a weatherproof cover when not in use. Two or four of the six channels supplied by the 19-pin connector may be dedicated for use by the modular energy pallet's onboard inverters, to supply AC current. When additional current, above what the onboard inverters can supply, is desired, an additional modular energy pallet 200 may be stacked on top of the first modular energy pallet 200 and the stacked modular energy pallet 200 may be patched into the first modular energy pallet 200, by routing power from the remaining two or four channels not dedicated to the onboard inverters. Up to three modular energy pallets 200 may be connected in this manner via a single 19-pin configuration.

The control and patch panel 400 also includes a direct battery output section 416 that enables supply of current from the battery 216 without attenuation. The direct battery output section 416 includes a switch 418 that, when enabled, causes current to flow from the battery 216 through the BMS 224 through a contactor of the switch 418 to an outlet 420. In the illustrated embodiment, the outlet 420 supplies 51VDC/51A power output from the battery 216. The active output is indicated by the direct power outlet indicator 422, which remains active when power is supplied to the outlet 420 and is otherwise inactive.

The control and patch panel 228 also includes a work light switch 424, which may control whether an operator work light of the modular energy pallet 200 receives power and activates. When activated, the work light switch 424 may complete an electrical circuit between the battery 216 and the work light, causing power to be supplied from the battery 216 to the onboard work light, resulting in activation of the work light. When de-activated, the work light switch 424 refrains from providing power to the work light, reserving power for other applications.

The control and patch panel 228 may also include an access point section 426. This section enables communication via an onboard wireless access point. The switch 428, when activated, supplies power to the onboard access point, enabling the electronic communication. The components utilizing the power from the modular energy pallet 200 may be communicatively couple to the access point via the onboard bulkhead ethernet port 430, which may be weatherproof while in and out of use. This enables wireless communicative control via an external control system through use of a physical ethernet connection between the access point and the controlled component. When de-activated, the switch 428 refrains from providing power to the access point, reserving power for other applications. In some embodiments, the control and patch panel 228, such as in the illustrated control and patch panel 400, may include an emergency disconnect affordance 432. The emergency disconnect affordance 432, when actuated, may cause all power output to be disabled (e.g., both AC and DC power). In some embodiments, an additional and/or alternative emergency disconnect affordance 432 may be disposed elsewhere on the modular energy pallet.

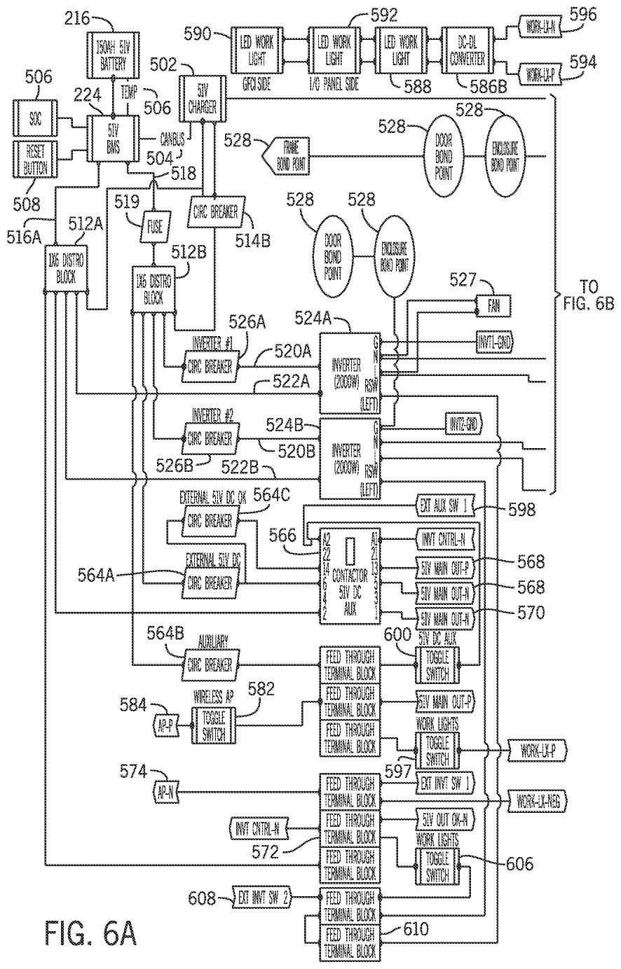

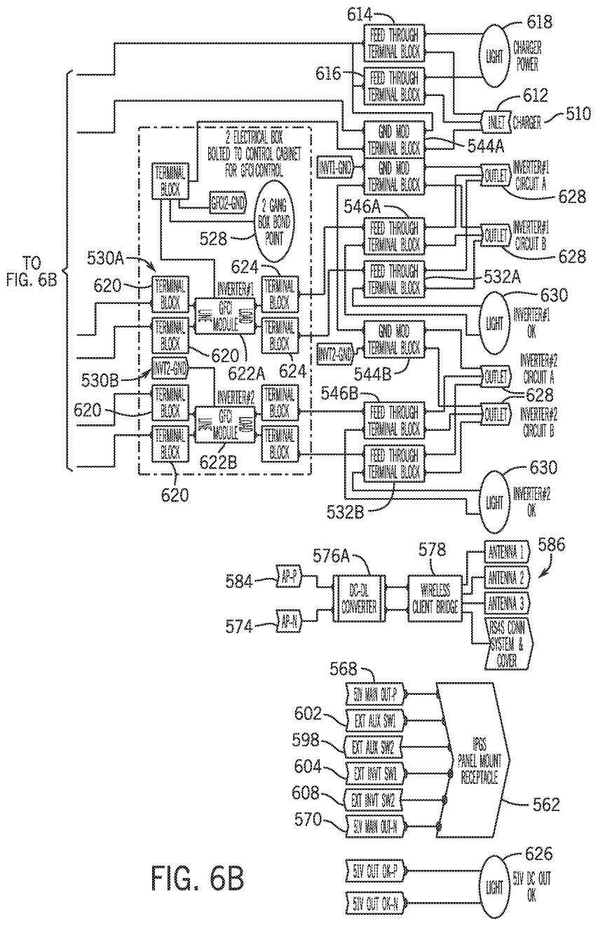

Turning now to wiring configurations of the 19-pin and weatherproof locking embodiments of the modular energy pallet 200, FIG. 5 is a 19-pin wiring diagram 500, illustrating connections of a 19-pin output version of the modular energy pallet, in accordance with one or more embodiments of the current disclosure. FIG. 6 is a wiring diagram, illustrating connections of a weatherproof locking output version of the modular energy pallet, in accordance with one or more embodiments of the current disclosure. Because there is substantial overlap in the wiring, these figures will be discussed together. While the following discussion details specific examples of embodiments of modular energy pallets, with particular electrical connections and components, the discussion is not intended to limit the embodiments to such electrical connections and components. Indeed, as those of ordinary skill in the art would appreciate, a number of variations in electrical connections and/or components may be possible in creating modular energy pallets.

As mentioned above, the battery 216 may be charged in accordance with instructions from the battery management system (BMS) 224. The BMS 224 may receive charging data from a charger 502 via a controller area network BUS (CANBUS) 504. Data provided via the CANBUS 504 may enable the BMS 224 to provide features such as over-charge (e.g., high-voltage cutoff) protection, over-discharge (e.g., low-voltage cutoff) protection, general battery 216 health monitoring, and other battery management functions, while charging the battery 216. Further, the BMS 224 may periodically monitor battery 216 temperatures 505 and a state of charge (SOC) 506, which may also be useful in charging control. In some embodiments, the CANBUS 504 may be communicatively coupled to each of the battery 216, the charger 502, the BMS 224, and the SOC 506 to provide features in an efficient and effective manner. A physical reset button 508 may, when actuated, cause a reset of charging and/or power distribution by the battery 216. For example, as discussed above, the reset button 508 may be communicatively coupled to the BMS 224 (e.g., in a wired or wireless fashion) and, when actuated, may reset the battery 216 charging and/or power distribution by isolating the battery 216 (e.g., for a temporary time) from a load and/or the charger 226, causing the battery 216 to refrain from providing power to the load and/or charging. To do this, the reset button 508, via actuation, causes a main contactor of the BMS 224 to break the load and/or charging circuits. Further, in some embodiments, the reset button 508, when actuated, may also trigger reset of one or more of the battery 216 statistics maintained by the BMS 224.

A charger circuit 510 may supply power to the charger 502. For example, as illustrated in FIG. 6, power may be supplied by a weatherproof locking Top Inlet 612 to positive feed-through terminal block 614 and negative feed-through terminal block 616, which may supply power to a charger power indicator light 618 and the charger 502. Accordingly, the charger power indicator light 618 may activate when power is being supplied to the charger 502, indicating that the battery 216 is charging.

The charger 502 may be coupled to power distribution blocks, such as 1×6 power distribution blocks 512A and 512B, with a negative connection being coupled to one (e.g., power distribution block 512A) and a positive connection coupled to another (e.g., power distribution block 512B) with an intervening 50A low voltage limiter fuse 514A (FIG. 5) and/or 50A circuit breaker 514B (FIG. 6).

A main negative connection 516 may couple the BMS 224 and a power distribution block (e.g., 1×6 power distribution block 512A). A main positive connection 518 may couple the BMS 224 and another power distribution block (e.g., the 1×6 power distribution block 512B) with an intervening 150A fuse 519. These connections may enable the battery 216 to charge via power provided by the charger circuit 510 and charger 502.

Turning now to a discussion of providing power from the battery 216 to the outlets and accessories of the modular energy pallet 200, the power distribution blocks (e.g., 1×6 power distribution blocks 512A and 512B) may provide a positive coupling 520A and a negative coupling 522A to one or more inverters (e.g., a first inverter 524A and a positive coupling 520B and a negative coupling 522B to a second inverter 524B). The positive couplings (e.g., positive couplings 520A and 520B) from the power distribution block (e.g., 1×6 power distribution block 512B) to respective inverters (e.g., inverters 524A and 524B) may include respective intervening circuit breakers (e.g., circuit breakers 526A and 526B) to provide protection against overcurrent.

In the current embodiment, the inverters 524A and 524B are 2000 W inverters, however other inverters may be used in other embodiments. One or more of the inverters 524A and 524B may a fan (e.g., power enclosure fan 527) and may both be grounded to frame, door, and/or enclosure bond points 528. Output of the inverters (e.g., inverters 524A and 524B) may be coupled to respective ground fault circuit interrupters (GFCIs) (e.g., GFCIs 530A and 530B, with the output of the GFCIs 530A and 530B). For example, as illustrated in FIG. 6, line and neutral connections of each inverter 524A and 524B are coupled to respective terminal blocks 620. The terminal blocks 620 are coupled to the line side of the respective GFCI modules 622A and 622B. A load side of the GFCI modules 622A and 622B are coupled with respective terminal blocks 624.

The GFCIs (e.g., GFCIs 530A and 530B) are coupled to respective feed-through terminal blocks (e.g., terminal blocks 532A and 532B, which provide line inputs 533A and 533B to the outlets (e.g., channels 534A and 534B of the 19-Pin connection and/or AC outlets 536A and/or 536B in FIG. 5 and weatherproof locking Top Outlets 628 of FIG. 6)). Neutral outputs (e.g., neutral outputs 538A and 538B) and ground outputs (e.g., ground outputs 540A and 540B) for outlets (e.g., the outlets 536A and 536B, respectively), may be provided via a coupling to enclosure, door, and/or frame bond points 542 and/or ground modular terminal block(s) (e.g., terminal block(s) 544A or 544B and/or feed-through terminal block(s) 546A or 546B). As illustrated in FIG. 6, in some embodiments, inverter status lights may be powered by GFCI modules (e.g., the GFCI modules 622A and 622B), providing an inverter OK status indication when lit.

As mentioned above, in the pinned output embodiments (e.g., 19-pin embodiments), the additional channels 534C may be used to provide power from other stacked modular energy pallets 200. As illustrated, inlets (e.g., the inlets 548A and 548B) supply respective line connections (e.g., line connections 550A and 550B), neutral connections (e.g., neutral connections 552A and 552B), and ground connections (e.g., ground connections, 554A and 554B). The line connections 550A and 550B are supplied to respective feed-through terminal blocks 556A and 556B, respectively. The neutral connections 552A and 552B are supplied to respective feed-through terminal blocks 558A and 558B, respectively. The ground connections 554A and 554B are supplied to respective ground modular terminal blocks 560A and 560B, respectively. The feed-through terminal blocks 556A, 556B, 558A, and 558B and the ground modular terminal blocks 560A and 560B are coupled to the channels 534C providing feedthrough power from the stacked modular energy pallets 200.

Returning to a discussion of selective component activation, the power distribution blocks (e.g., 1×6 power distribution blocks 512A and 512B) may selectively distribute power from the battery 216 to other components. For example, in the depicted embodiment, power distribution blocks (e.g., the 1×6 power distribution blocks 512A and 512B) may provide direct DC power to a panel mount receptacle 562, by coupling a positive output, through a circuit breaker (e.g., circuit breaker 564A), and a negative output to a contactor (e.g., contactor 566), respectively. The contactor 566 may provide a positive output 568 (e.g., 51V, matching the battery 216) and a negative output 570 (e.g., 51V, matching the battery 216) to the panel mount receptacle 562, thus providing a direct DC power connection from the battery 216.

Toggle switches may selectively provide power to other components as well. For example, a power distribution block (e.g., the 1×6 power distribution block 512A) may provide a negative output to a feed-through terminal block 572, which supplies an access point negative output 574 to a DC-DC converter 576A that supplies power to an onboard wireless access point 578. The 1×6 power distribution block 512B may supply a positive output from the battery 216 to the circuit breaker 564B, coupled to the feed-through terminal block 580. The access point toggle switch 582, when activated, supplies a positive access point output 584 from the feed-through terminal block 580 to the DC-DC converter 576A, which provides the positive access point output 584 to the onboard wireless access point 578, thus enabling access point communication via antenna array 586.

Other components, such as an LED work light 588, a connector work light 590, and/or a control and patch panel work light 592 (hereinafter “work lights”) may be selectively enabled as well. For example, as illustrated, a work light positive output 594 and a work light negative output 596 may provide power from the battery 216 via the feed-through terminal blocks 580 and 572, respectively. The signals from the feed-through terminal blocks 580 and 572 flow through a DC-DC converter 576B for voltage stabilization to power the work lights. A work light toggle switch 597 may control whether the power supplied to the work lights by blocking power flow when deactivated, causing deactivation of the work lights. Additionally, terminal block 572 may provide a neutral DC status output for the DC out status light 626. The positive output for the DC out status light 626 may be supplied by the contactor 566 based upon an output from circuit breaker 564C (e.g., 2A) supplied from the circuit breaker 564A to the contactor 566.

The external Aux switch signal 598 and/or the DC toggle switch 600 may be coupled to the contactor 566. Signals from these components may indicate whether DC power is supplied by the contactor 566 (e.g., via positive output 568 (e.g., 51V, matching the battery 216) and a negative output 570 (e.g., 51V, matching the battery 216) supplied to the panel mount receptacle 562)). When activated, these components indicate that power should flow to the panel mount receptacle 562.

The external Aux switch signal 602 and the external Inverter switch signal 604 provide an activation status for the DC toggle switch 600 and the inverter toggle switch 606, respectively. These status indications are provided via the panel mount receptacle 562 for use by other modular energy pallets 200.

The inverters toggle switch 606 and/or the external inverter switch signal 608 selectively controls whether the inverters 524A and 524B are activated. Activation and/or deactivation signals may be provided via a feed-through terminal block 610, via a coupling to the inverters 524A and 524B, as illustrated.

While only certain features of the invention have been illustrated and described herein, many modifications and changes will occur to those skilled in the art. It is, therefore, to be understood that the appended claims are intended to cover all such modifications and changes as fall within the true spirit of the invention.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A modular energy pallet, comprising:
a battery;
one or more selectively enabled outlets that when selectively enabled provide power from the battery via the outlets; and
an enclosure system, comprising:
one or more skid rails disposed at a base of the enclosure system.

2. The modular energy pallet of claim 1, wherein the battery comprises a 51-volt (V), 150 Amp-hour (Ah) battery.

3. The modular energy pallet of claim 1, comprising one or more inverters configured to convert DC power from the battery to AC power.

4. The modular energy pallet of claim 3, wherein the one or more selectively enabled outlets comprise: an AC outlet that provides the AC power.

5. The modular energy pallet of claim 4, wherein the AC outlet comprises a weatherproof 19-pin output that utilizes a first subset of available channels of the 19-pin output for provision of the AC power.

6. The modular energy pallet of claim 5, configured to receive additional AC power from a second stackable modular energy pallet and route the additional AC power through one or more open channels of the available channels to provide the additional AC power through the AC outlet.

7. The modular energy pallet of claim 1, wherein the one or more selectively enabled outlets comprise a first DC outlet configured to provide direct power from the battery.

8. The modular energy pallet of claim 1, comprising:
a selectively enabled access point powered by the battery, that, when enabled, is configured to couple with a component powered by the modular energy pallet.

9. The modular energy pallet of claim 1, comprising:
one or more selectively enabled work lights powered by the battery, wherein the one or more selectively enabled work lights comprise:
a first work light configured to illuminate a control and patch panel of the modular energy pallet;
a second work light configured to illuminate the one or more selectively enabled outlets; or
both.

10. The modular energy pallet of claim 1, wherein the one or more skid rails are disposed at the base of the enclosure system in a manner that creates one or more fork pockets for one or more forks of a fork lift.

11. The modular energy pallet of claim 1, comprising:
a battery restraint system disposed within the enclosure system, wherein the battery securing system configured to secure the battery within the modular energy pallet.

12. The modular energy pallet of claim 1, comprising:
an onboard battery management system; and
an onboard charger configured to charge the battery in accordance with a scheme of the onboard battery management system.

13. A modular energy pallet system, comprising:
a first modular energy pallet, configured to provide power from an onboard battery of the first modular energy pallet via a first one or more selectively enabled outlets, wherein the first modular energy pallet comprises: one or more first skid rails disposed at a base of the first modular energy pallet; and
a second modular energy pallet, configured to receive, at a top of second modular energy pallet, the one or more first skid rails and supply supplemental power via a second one or more selectively enabled outlets.

14. The modular energy pallet system of claim 13, wherein the one or more first skid rails are shaped and sized such that a fork of a fork lift may fit within the one or more first skid rails and the fork may be removed after the first one or more skid rails are received by the second modular energy pallet.

15. The modular energy pallet system of claim 13, wherein the first one or more selectively enabled outlets and the second one or more selectively enabled outlets comprise: an AC outlet that provides AC power via inverters that convert DC power to the AC power;
wherein the AC outlet comprises a weatherproof 19-pin output that utilizes a first subset of available channels of the 19-pin output for provision of the AC power.

16. The modular energy pallet system of claim 15, wherein the first modular energy pallet is configured to:
provide AC power of the first modular energy pallet to a powered component via a single 19-pin connection between the powered component and the first modular energy pallet;
receive and route AC power from the second modular energy pallet as a supplement to the AC power from the first modular energy pallet via the single 19-pin connection.

17. The modular energy pallet system of claim 16, comprising:
a third modular energy pallet, wherein the first modular energy pallet is configured to receive and route AC power of the third modular energy pallet to the powered component via the single 19-pin connection with the AC power of the first modular energy pallet and the AC power of the second modular energy pallet.

18. The modular energy pallet system of claim 13, wherein the first modular energy pallet, the second modular energy pallet, or both, comprise:
a selectively enabled access point, that, when enabled, is configured to couple via a bulkhead connector with a device powered by the modular energy pallet system.

19. A method, comprising:
powering a DC powered attraction component via a modular energy pallet by:
selectively enabling a DC outlet of the modular energy pallet; and
coupling the DC powered attraction component to the selectively enabled DC outlet of the modular energy pallet, wherein DC power powering the DC powered attraction component is supplied direct from an onboard battery of the modular energy pallet; and
powering an AC powered attraction component via the modular energy pallet by:
selectively enabling an AC outlet of the modular energy pallet; and
coupling the AC powered attraction component to the selectively enabled AC outlet of the modular energy pallet, wherein AC power powering the AC powered attraction component is supplied from the onboard battery via one or more inverters.

20. The method of claim 19, comprising:
wirelessly controlling the DC powered attraction component, the AC powered attraction component, or both, via a wireless access point connection to an access point coupled to a controller of the DC powered attraction component, the AC powered attraction component, or both.
